(19) United States
(12) Patent Application Publication
(10) Pub. No.: US 2023/0295509 A1
(43) Pub. Date: Sep. 21, 2023

(54) STEERABLE ANTENNA AND METHOD FOR HEATING AND/OR TEMPERING OF A STEERABLE ANTENNA

(71) Applicant: MERCK PATENT GMBH, DARMSTADT (DE)

(72) Inventors: Michael WITTEK, Darmstadt (DE); Carsten FRITZSCH, Darmstadt (DE); Dagmar KLASS, Darmstadt (DE)

(73) Assignee: MERCK PATENT GMBH, DARMSTADT (DE)

(21) Appl. No.: 17/924,024

(22) PCT Filed: Jun. 7, 2021
(86) PCT No.: PCT/EP2021/065086

§ 371 Date: Nov. 8, 2022

(30) Foreign Application Priority Data
Jun. 10, 2020 (EP) 20179131.6

(51) Int. Cl. C09K 19/18; H01Q 3/28; H01Q 3/36; C09K 19/30; C09K 19/12

(52) U.S. Cl. CPC C09K 19/18; C09K 19/12; C09K 19/3003; C09K 19/3059; H01Q 3/28; H01Q 3/36; C09K 2019/123; C09K 2019/181; C09K 2019/183; C09K 2019/3016; C09K 2019/3063; C09K 2219/11

(57) ABSTRACT

A steerable antenna having a plurality of radiating elements and a plurality of modifier elements configured for shifting phase and/or adjusting amplitude of a signal to be emitted by the radiating elements is disclosed. Each of the radiating elements is coupled to one of the modifier elements, wherein the modifier elements each comprise a liquid crystalline medium and wherein the modifier elements are configured such that the adjustment of the phase and/or amplitude is dependent on a state of the liquid crystalline medium. The steerable antenna further comprises a signal generator connected to the modifier elements and configured for generating a signal suited for dielectric heating of the liquid crystalline media of the modifier elements. Further aspects relate to a method for heating and/or controlling the temperature of the liquid crystalline medium of such a steerable antenna.

The invention relates to a steerable antenna comprising a plurality of radiating elements and a plurality of modifier elements configured for shifting phase and/or adjusting amplitude of a signal to be emitted by the radiating elements, wherein one or more of the radiating elements is coupled to one or more of the modifier elements, wherein the modifier elements each comprise a liquid crystalline medium and wherein the modifier elements are configured such that the adjustment of the phase and/or amplitude is dependent on a state of the liquid crystalline medium. Further, the invention relates to a method for heating and/or controlling the temperature of the liquid crystalline medium of such a steerable antenna.

Especially in satellite communication and microwave terrestrial communication systems, steerable antennas are useful to ensure that the antenna is continuously pointing towards the satellite or terrestrial communication partner. A steerable antenna may be mechanically moved in order to move the antenna beam. Phased antenna arrays are known in the art and allow steering of a main beam direction of the antenna without making use of moving parts. Such phased antenna arrays comprise several individual antenna elements wherein the relative phase between the individual elements may be controlled in order to control the antenna beam direction.

The article by C. Fritzsch et al. (2019). 77-1: “Invited Paper: Liquid Crystals beyond Displays: Smart Antennas and Digital Optics”. SID Symposium Digest of Technical Papers. 50. 1098-1101. DOI: 10.1002/sdtp.13120 describes applications of liquid crystals in other fields of technology. In particular, the use of liquid crystals in electronic beam steering antennas is disclosed. Such antennas can point their antenna beam in different directions without any mechanical moving parts. Such an antenna comprises a plurality of liquid crystal based phase shift elements which are connected to radiating elements of the antenna. By introducing a specific incremental phase shift the phase front of the radiated field may be tilted and thus the antenna beam is also tilted towards the desired direction.

US 2014/0266897 A1 discloses a two-dimensional beam steerable phased array antenna. The antenna comprises a plurality of power dividers, a plurality of electronically tunable phase shifters and a plurality of radiating elements. An individual element of the antenna comprises at least an electronically tunable phase shifter, a biasing network and a radiating element. The phase shifter comprises a liquid crystal material which is tunable by means of an applied electric field. The phase shifters each comprise a meandered microstrip line arranged next to the liquid crystal material. The microstrip line is coupled to the radiating element. The article by H. Maune et al. “Microwave Liquid Crystal Technology”, Crystals 2018, 8(9), 355, DOI: 10.3390/cryst8090355 describes different tunable liquid crystal (LC) based microwave components. In particular, LC based phase shifters having dielectrically filled rectangular waveguides are described.

The article by A. Gaebler et al. “Liquid Crystal-Reconfigurable Antenna Concepts for Space Applications at Microwave and Millimeter Waves”, (February 2009), International Journal of Antennas and Propagation, Vokl 2009, Article ID 876989, DOI: 10.1155/2009/876989 describes a phase shifter comprising planar low temperature cofired ceramics sheets forming a microstrip line which is filled with liquid crystal. By application of an electrical bias field, the effective permittivity of the transmission line may be tuned.

The article by Tien-Lun Ting “Technology of liquid crystal based antenna” 10 Jun. 2019, Optics Express 17138 Vol 27, No 12, DOI:10.1364/OE.27.017138 describes several liquid crystal based phase shifters. One type of phase shifter comprises a microstrip line wherein a signal line is arranged adjacent to a liquid crystal layer having a thickness larger than 100 µm. Another type comprises a coplanar waveguide arranged adjacent to a thin liquid crystal layer with a cell gap of typically less than 10 µm.

US 2015/0288063 A1 discloses a holographic metamaterial antenna comprising a waveguide and a metamaterial layer coupled to the waveguide as a top-lid of the waveguide. The antenna further comprises an array of tunable slots arranged in the top-lid of the waveguide. The tunable slots may be tuned by tuning a dielectric material within the tunable slot. In one embodiment, the dielectric material is a liquid crystal which is tuned by varying a voltage applied across the liquid crystal. For steering of an antenna beam, a holographic diffraction pattern is determined and the array of tunable slots is driven in accordance with the determined diffraction pattern.

The properties of the used liquid crystalline media are dependent on temperature. Especially if the antenna is to be operated in low temperature conditions, it is usually required to include heating elements in order to heat the liquid crystal.

US 2019/0229431 A1 discloses a scanning antenna comprising in this order a TFT substrate having patch electrodes, a liquid crystal layer, a slot electrode having slots, a dielectric substrate and a reflective conductive plate. The reflective conductive plate and the slot electrode form a waveguide for microwaves. The antenna comprises a plurality of antenna units, each antenna unit having a corresponding slot in the slot electrode and corresponding patch electrode. The phase of the microwave excited from each patch electrode is changed by changing the electrostatic capacitance value of the liquid crystal capacitance of the antenna unit. The antenna may further comprise a heater resistive film for heating of the liquid crystal layer.

US 2018/0146511 A1 discloses an antenna having a physical antenna aperture having an array of radio frequency (RF) antenna elements. The RF antenna elements may comprise a liquid crystalline medium. Further, the antenna comprises a plurality of heating elements which are arranged between pairs of RF antenna elements of the array of RF antenna elements. The heating elements are configured as a heating wire. For monitoring the temperature of the liquid crystalline medium, a temperature sensor may be used. In another embodiment, the capacitance of the liquid crystal may be used for temperature measurement.

The additional heating elements, for example resistive heating elements in the form of a wire heater or resistive film, are usually arranged outside of the antenna elements. Thus, heating of the liquid crystalline medium of the antenna elements is delayed as the heat introduced by the heating elements must propagate to the liquid crystalline medium by heat conduction. Also, the liquid crystalline medium is not heated uniformly so that a long waiting time is required for reaching thermal equilibrium within the LC medium. Thus, it would be desirable to directly heat the liquid crystalline medium.

Dielectric heating is a process in which an alternating electric field heats a dielectric medium, such as a liquid crystalline medium. This heating is caused by molecular dipole rotation within the dielectric. Polar molecules have electrical dipole moments. These dipole moments align themselves in an alternating electric field, with the consequence that the rotating molecules push, pull and collide with other molecules through electrical forces, distributing the energy to adjacent molecules and atoms in the material. As temperature is related to the average kinetic energy of the atoms and molecules in a material, this process increases the temperature of the material.

Alternating electric fields may cause dielectric heating in liquid crystals. In the article by M. Schadt (1981) “Dielectric Heating and Relaxations in Nematic Liquid Crystals”, Molecular Crystals and Liquid Crystals, 66:1, 319-336, DOI:10.1080/00268948108072683 experiments are described in which dielectric heating was used to induce changes of temperature in nematic liquid crystal layers.

It is also known to make use of dielectric heating for controlling the temperature of a liquid crystal layer in an optical device. EP 0 370 627 A2 discloses an optical device which may be switched between an opaque and a transparent state. The device comprises an optical material containing dispersed liquid crystal droplets. The optical material is arranged between indium-tin-oxide coated plates. In order to raise the temperature of the device, a high-frequency heating electric field is applied to the optical material causing dielectric heating in the optical material.

EP 3 349 208 A1 discloses a liquid crystal display device which includes an upper substrate, a lower substrate and a liquid crystal layer between the two substrates. A change in the capacitance of the liquid crystal layer is detected using a current sensor and the temperature of the liquid crystal layer is determined using the detected capacitance. A driving signal is controlled dependent on the temperature in order to compensate for temperature dependent properties of the liquid crystal layer. Look-up tables may be used for deriving the temperature and for determining the required correction.

There is a need for a steerable antenna which may be operated over the full temperature range required for industrial and automotive applications, in particular for low temperatures in the range of from about -40° C. to 0° C. and which may quickly and reliably be tempered to the required operating temperature.

A steerable antenna comprising a plurality of radiating elements and a plurality of modifier elements configured for shifting phase and/or adjusting amplitude of an antenna signal to be emitted by the radiating elements is proposed, wherein one or more of the radiating elements is coupled to one or more of the modifier elements, wherein the modifier elements each comprise a liquid crystalline medium and wherein the modifier elements are configured such that the adjustment of the phase and/or amplitude is dependent on a state of the liquid crystalline medium. The steerable antenna further comprises a signal generator connected to the modifier elements and configured for generating a heating signal suited for dielectric heating of the liquid crystalline media of the modifier elements.

In a preferred embodiment, each of the radiating elements is coupled to a plurality of modifier elements.

In another preferred embodiment, a plurality of radiating elements is coupled to each modifier element.

Preferably, the radiating elements are arranged in form of a grid or in form of concentric rings. Further, it is preferred to arrange the radiating elements in a plane so that an active part of the steerable antenna comprising the radiating elements is essentially flat.

The modifier elements are used to adjust the phase and/or the amplitude of the radiation emitted by the radiating element connected to the respective modifier element. This adjustment of the phase and/or amplitude is dependent on the state of the liquid crystalline medium. The state of the liquid crystalline medium may be controlled by means of an electric field. Accordingly, the modifier elements comprise electrodes which are configured to apply an electric field to the liquid crystalline medium. The electric field may be controlled by applying a control signal to the respective electrodes.

Preferably, the modifier elements are configured as phase shifters. A phase shifter is a device which changes the signal phase and has ideally a flat phase response over the frequency of the antenna signal. When the modifier elements are configured as phase shifters, the steerable antenna is configured as a phased array antenna. The phase response of liquid crystal based phase shifters may depend on frequency of the antenna signal. However, by taking the frequency response into account, liquid crystal based phase shifters may be used for phased array antennas.

In a phased array antenna, an antenna signal is distributed to the phase shifters which are connected to the radiating elements. If all phase shifters are configured to produce an in-phase output, the phase front of the radiated signal is aligned parallel to the antenna surface, therefore directing the antenna beam perpendicular to the antenna surface. When introducing a specific incremental phase shift, the phase front of the radiated fields is tilted and therefore the antenna beam is also tilted towards the desired direction. The same principle applies mutatis mutandis to signals received by the phased array antenna.

The phase shifters comprise the liquid crystalline medium as active component for adjusting the phase of the signal. Further, phase shifters preferably have a waveguide which is configured to transmit the antenna signal.

Preferably the antenna comprises modifier elements configured as variable attenuators, very preferably each connected to a modifier element configured as a phase shifter, respectively.

The dimensions of the active part of the steerable antenna which comprises the radiating elements, e.g. the diameter or the length and the width, depend on the frequency of the radiation (signal to be sent or received by the antenna). Theoretically, the distance between two radiating elements is λ/2 where λ is the wavelength of the radiation emitted or received, respectively. In case of a square shaped antenna having a number of “N×N” radiating elements, with “N” being an integer, preferably in the range from 10 to 100, the size of the active part of the steerable antenna is about N(λ/2)×N(λ/2) for the length and width.

The overall dimensions of the active part of the antenna influence the antenna gain. Accordingly, the overall dimensions of the active part are chosen depending on the desired antenna gain. For example, a square shaped steerable antenna may comprise an active part having an edge lengths in the range of 5 cm to 500 cm and the number of radiating elements may be chosen in the range of from 2×2 (4 elements) to 100×100 (10 000 elements). Typical overall dimensions of the active part (aperture size) are in the range of from 40 cm × 40 cm to 80 cm × 80 cm for satellite communication.

Preferably, the waveguide is configured as microstrip line or coplanar waveguide arranged adjacent to a liquid crystal layer or as hollow waveguide at least partially filled with liquid crystalline medium.

In a microstrip line, a signal line carrying the antenna signal to be emitted or received by the antenna is arranged adjacent to a ground plane, wherein the signal line and the ground plane are separated by a gap or a dielectric substrate. Several variants of microstrip lines are known to the expert in the art. Preferably, the microstrip line is configured as an inverted microstrip line wherein the ground plane and the conducting line are each arranged on a separate substrate and the substrates are arranged such that both the ground plane and the signal line face a gap filled with the liquid crystalline medium. The gap width in such a configuration is typically larger than 100 µm.

The ground plane is preferably used as one of the electrodes used for applying an electric field to control the state of the liquid crystalline medium. The signal line may be used as second electrode for applying the electric field by means of a control signal. When an electric field is applied, the orientation of the liquid crystals in the liquid crystalline medium is changed and accordingly, a shunt capacitance perceived by a signal propagating through the microstrip line is altered.

In a coplanar waveguide a signal line carrying the antenna signal to be emitted or received by the antenna is arranged on a first substrate together with a pair of ground lines arranged on either side of the signal line. For forming of a cavity for enclosing the liquid crystalline medium, a second substrate is arranged facing the side of the first substrate carrying the signal line. The cavity is filled with the liquid crystalline medium. The gap width and thus the thickness of the liquid crystal layer is typically less than 10 µm.

A top electrode may be arranged on the surface of the second substrate facing towards the cavity. For application of an electric field for controlling the state of the liquid crystalline medium, the signal line may be used as first electrode. The top electrode and/or the ground lines may be used as second electrode for applying the electric field for controlling the state of the liquid crystalline medium. The top electrode and the ground lines may be electrically connected.

Phase shifters configured as microstrip line or coplanar waveguide are for example described in the article by Tien-Lun Ting “Technology of liquid crystal based antenna” 10 Jun. 2019, Optics Express 17138 Vol 27, No 12, DOI:10.1364/OE.27.017138.

In a phase shifter comprising a hollow waveguide, biasing electrodes are arranged on two opposing surfaces of the hollow waveguide which may, for example be configured as a metallic rectangular waveguide. The hollow waveguide is at least partially filled with liquid crystalline medium and the orientation state of the liquid crystalline medium is controlled by means of an electric field which may be controlled by applying a control signal to the two biasing electrodes.

Such a phase shifter is, for example, described in the article by H. Maune et al. “Microwave Liquid Crystal Technology”, Crystals 2018, 8(9), 355, DOI: 10.3390/cryst8090355.

In another embodiment of the invention, the steerable antenna is configured as a holographic antenna. In such a holographic antenna, a holographic emission pattern is formed. The beam direction and beam shape of an emitted antenna signal may be modified by modification of the hologram form.

The radiation emitting elements in such a holographic steerable antenna are preferably part of a metamaterial layer, wherein the holographic pattern is controlled by means of the modifier elements. Such holographic steerable antenna having a waveguide and a metamaterial layer coupled to the waveguide is, for example, known from US 2015/0288063 A1.

The modifier elements are, for example, configured as resonant elements wherein the resonance frequency is dependent on the state of the liquid crystalline medium. The modifier element may comprise a cavity which is at least partially filed with the liquid crystalline medium and has electrodes for applying an electric field for controlling of the orientation state of the liquid crystalline medium. In order to control the electric field, a control signal may be applied to the electrodes.

In such a holographic steerable antenna, it is preferred that the steerable antenna further comprises a common waveguide with a plurality of slots, wherein the modifier elements are arranged between the common waveguide and the slots. The modifier elements are configured such that they at least control the amplitude of the radiation emitted by the respective radiating element by adjusting a reactance of the respective slot.

Preferably, the steerable antenna includes a metamaterial layer comprising the plurality of slots and the modifier elements. Each of the plurality of slots is coupled to a radiating element and the radiating elements are preferably arranged in form of an array. By means of the modifier elements, the array of radiating elements can be configured to form holographic diffraction patterns to steer an antenna signal emitted by the antenna.

The antenna signal to be emitted is fed by means of the common waveguide and is guided to the radiating elements through the tunable slots, wherein by means of the modifier elements the reactance of each of the tunable slots can be adjusted depending on the electric field applied to the liquid crystalline medium of the respective modifier element.

The spacing of the radiating elements is preferably less than λ/2 so that the active part of the antenna comprising the radiating elements acts as a metamaterial layer with respect to the emitted or received signal. Further, the overall dimensions such as diameter or edge length of the active part of the antenna are preferably dimensioned to be many wavelengths in length.

The liquid crystalline medium is preferably chosen such that good tunability is provided in the desired frequency range for the antenna signal and further that the liquid crystalline medium has a low absorption or loss for the antenna signal to be emitted or received by the antenna. Two key parameters for the liquid crystalline medium used are the tunability and the dielectric loss tangent.

The tunability τ may be calculated by

$$τ = \frac{{ε}_{∥} - {ε}_{⊥}}{{ε}_{∥}}$$

wherein εₗₗ is the permittivity parallel to the molecular axis and ε_{⊥} is the permittivity perpendicular to the molecular axis. The tunability τ describes the highest possible relative permittivity change of the liquid crystalline medium.

The dielectric loss tangent tan δ is defined by the ratio of the imaginary and real part of the permittivity at the respective signal frequencies and is given by

$$tan {δ}_{∥ , ⊥} = \frac{{{ε}^{″}}_{∥ , ⊥}}{{{ε}^{′}}_{∥ , ⊥}}$$

The dielectric loss tangent tan δ is a figure for dielectric absorption and thus describes the absorption loss of the antenna signal. Accordingly, the liquid crystalline medium is chosen such that the tunability τ is maximized and the dielectric loss tangent tan δ is minimized for the desired frequency of the antenna signal.

The properties of the liquid crystalline medium, in particular the tunability τ, dielectric loss tangent tan δ, and the rotational viscosity (γ₁) are temperature dependent, where the rotational viscosity influences the response time. Accordingly, the temperature of the liquid crystalline medium is preferably controlled to a set operating temperature. In particular, the liquid crystalline medium is heated in order to achieve the desired operating temperature, especially in view of the response time. A fast response requires a low rotational viscosity.

In the steerable antenna of the present invention, a signal generator is provided which is connected to the modifier elements and configured for generating a heating signal suited for dielectric heating of the liquid crystalline media of the modifier elements.

Dielectric heating is a process in which the applied signal causes an alternating electric field that heats the liquid crystalline medium. This heating is caused by molecular dipole rotation within the medium. The liquid crystal molecules in the liquid crystalline medium are polar molecules that have electrical dipole moments. These dipole moments align themselves in the alternating electric field, with the consequence that the rotating molecules push, pull and collide with other molecules through electrical forces, distributing the energy to adjacent molecules and atoms in the material. As temperature is related to the average kinetic energy of the atoms and molecules in a material, this process increases the temperature of the liquid crystalline medium.

The frequency of the heating signal suited for dielectric heating is preferably chosen several orders of magnitude smaller than the frequency of the antenna signal to be emitted by the steerable antenna. For example, the frequency used for dielectric heating is chosen in the range of from 10 Hz to 1 MHz and the frequency of the antenna signal is chosen in the range of from 1 GHz to 110 GHz The signal generator is configured accordingly to supply a heating signal of the chosen frequency.

The liquid crystalline medium and/or the frequency of the heating signal is/are preferably chosen such that the loss tangent tan δ has a maximum for the frequency of the heating signal.

As used herein, the optimum frequency for dielectric heating is the frequency at which the loss tangent tan δ has a maximum for a given temperature and orientation state of the liquid crystalline medium.

The medium used in the antenna according to the invention preferably has a clearing point of 90° C. or more, more preferably 100° C. or more, more preferably 110° C. or more, more preferably 120° C. or more, more preferably 130° C. or more, particularly preferably 140° C. or more and very particularly preferably 150° C. or more.

The nematic phase of the media used in the antenna according to the invention preferably extends at least from 0° C. or less to 90° C. or more. It is advantageous for the media according to the invention to exhibit even broader nematic phase ranges, preferably at least from -10° C. or less to 120° C. or more, very preferably at least from -20° C. or less to 140° C. or more and in particular at least from -30° C. or less to 150° C. or more, very particularly preferably at least from -40° C. or less to 170° C. or more.

The dielectric anisotropy (Δε) of the liquid-crystal medium used in the antenna according to the present invention, at 1 kHz and 20° C., is preferably 3 or more, more preferably 7 or more and very preferably 10 or more.

The birefringence (Δn) of the liquid-crystal media used in the antenna according to the present invention, at 589 nm (Na^{D}) and 20° C., is preferably 0.280 or more, more preferably 0.300 or more, even more preferably 0.320 or more, very preferably 0.330 or more and in particular 0.350 or more.

The Δn of the liquid-crystal media used in the antenna according to the present invention, at 589 nm (Na^{D}) and 20° C., is preferably in the range from 0.200 to 0.900, more preferably in the range from 0.250 to 0.800, even more preferably in the range from 0.300 to 0.700 and very particularly preferably in the range from 0.350 to 0.600.

Suitable liquid crystalline media are known from prior art. Preferred media are disclosed in for example WO2013/034227, EP2982730, EP 3312251, EP 3543313, and WO 2019/243223.

Very preferably, the antenna according to the invention comprises a liquid-crystalline medium comprising one or more compounds selected from the group of the formulae I, II and III

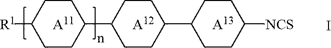

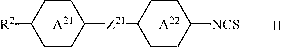

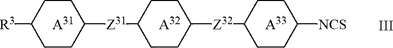

in which
R¹ denotes H, unfluorinated alkyl or unfluorinated alkoxy having 1 to 17 C atoms, or unfluorinated alkenyl, unfluorinated alkenyloxy or unfluorinated alkoxyalkyl having 2 to 15 C atoms, in which one or more CH₂-groups may be replaced by

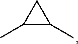

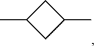

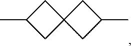

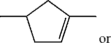

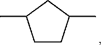

n is 0, 1 or 2,

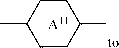

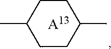

on each occurrence, independently of one another, denote 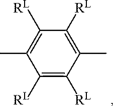 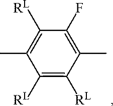 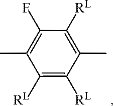 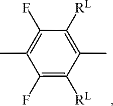 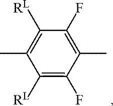 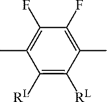 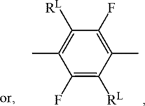
in which R^{L}, on each occurrence identically or differently, denotes H or alkyl having 1 to 6 C atoms,
and wherein 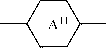
alternatively denotes 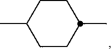 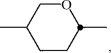 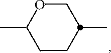 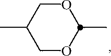 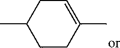 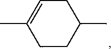
R² denotes H, unfluorinated alkyl or unfluorinated alkoxy having 1 to 17 C atoms, or unfluorinated alkenyl, unfluorinated alkenyloxy or unfluorinated alkoxyalkyl having 2 to 15 C atoms, in which one or more CH₂-groups may be replaced by

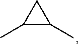

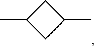

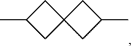

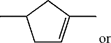

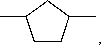

Z²¹ denotes trans—CH═CH—, trans—CF═CF— or —C═C—, and

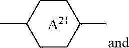

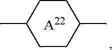

independently of one another, denote 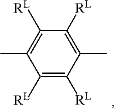 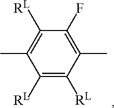 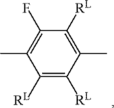 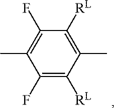 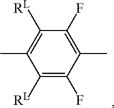 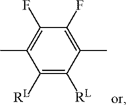 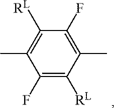
in which R^{L}, on each occurrence identically or differently, denotes H or alkyl having 1 to 6 C atoms;
R³ denotes H, unfluorinated alkyl or unfluorinated alkoxy having 1 to 17 C atoms, or unfluorinated alkenyl, unfluorinated alkenyloxy or unfluorinated alkoxyalkyl having 2 to 15 C atoms, in which one or more CH₂-groups may be replaced by

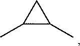

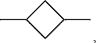

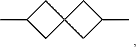

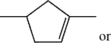

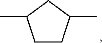

one of Z³¹ and Z³², denotes trans—CH═CH—, trans—CF═CF— or —C≡C— and the other one, independently thereof, denotes —C≡C—, trans—CH═CH—, trans—CF═CF— or a single bond, and

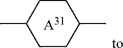

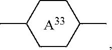

independently of one another, denote 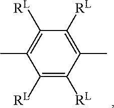 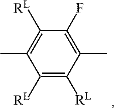 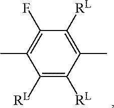 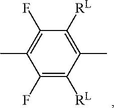 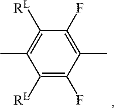 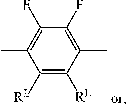 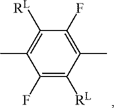
in which R^{L}, on each occurrence identically or differently, denotes H or alkyl having 1 to 6 C atoms,
and wherein 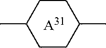
alternatively denotes

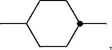

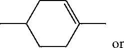

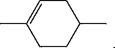

Using dielectric heating for tempering of the liquid crystalline medium of the modifier elements is particular useful in cold-start situations wherein the steerable antenna is powered up within a low temperature environment, in particular for temperatures below 0° C. Dielectric heating allows for quick heating of the liquid crystalline medium, the properties of which are temperature dependent. Operating temperature is reached much more quickly than by means of conventional electric heaters such as resistive heaters arranged in proximity to the liquid crystalline medium of a modifier element. By means of dielectric heating, the heat is directly generated within the liquid crystalline medium to be heated. There is no time delay due to heat conduction from an external heater to the liquid crystalline medium.

Preferably, each of the modifier elements has at least two electrodes, wherein a first electrode is configured for applying an electric field for adjusting the state of the liquid crystalline medium and a second electrode is connected to the signal generator and configured to apply an electric field for dielectric heating of the liquid crystalline medium.

Alternatively, each of the modifier elements has at least one electrode, which is configured for applying both an electric field for adjusting the state of the liquid crystalline medium and is further connected to the signal generator and configured to apply an electric field for dielectric heating of the liquid crystalline medium.

For generating the control signal as well as the heating signal, signal generators may be used. These signal generators may be provided in form of two independent signal generators. Alternatively, a common signal generator for both the control signal and the heating signal may be provided.

Preferably, the steerable antenna further comprises a temperature sensor configured to measure a temperature of the liquid crystalline medium of the modifier elements. This allows measurement of the temperature of the liquid crystalline medium. The measurement may, for example, be used for controlling the temperature or for providing feedback relating to the operational status of the steerable antenna.

Preferably, the steerable antenna further comprises a control unit which is configured to adjust the frequency of the heating signal suited for dielectric heating in dependence of the temperature of the liquid crystalline medium of the modifier elements. Accordingly, the control unit is connected to the signal generator and the signal generator is configured such that the frequency of the output signal may be adjusted in dependence of a control signal provided by the control unit.

The control unit may, for example, comprise a temperature controller such as a proportional-integral-derivative (PID) controller, for controlling the temperature of the liquid crystalline medium to a desired temperature setpoint.

Preferably, the antenna comprises means for measuring the power input of the dielectric heating and a tracking system configured to track the optimum frequency with a change of the temperature of the LC on the basis of the power input value. This is useful as the dielectric heating may be operated at the optimum frequency when the temperature changes, for example increases upon heating.

The steerable antenna may of course comprise further components such as, for example, a radome or protection layer which is arranged to cover the radiating element in order to provide protection from environmental influences. Further, the steerable antenna may comprise a further heater, for example an electric heating element, to provide further heating in addition to the dielectric heating of the respective liquid crystalline media of the modifier elements.

In a further aspect of the invention, a method of heating and/or tempering of a steerable antenna is provided. The steerable antenna comprises a plurality of radiating elements and a plurality of modifier elements configured for shifting phase and/or adjusting amplitude of an antenna signal to be emitted by the radiating elements, wherein each of the radiating elements is coupled to one of the modifier elements, wherein the modifier elements each comprise a liquid crystalline medium and wherein the modifier elements are configured such that the adjustment of the phase and/or amplitude is dependent on a state of the liquid crystalline medium. The method comprises applying an alternating electric field having a frequency suited for dielectric heating of the liquid crystalline medium to the liquid crystalline medium of the modifier elements.

The steerable antenna is preferably one of the steerable antennas described herein.

Preferably, a heating signal is applied to electrodes arranged in proximity and/or adjacent to the liquid crystalline medium in order to apply the alternating electric field for dielectric heating. For applying the electric field, a heating signal may be applied to said electrodes.

The frequency which is chosen for the heating signal used for dielectric heating is preferably chosen such that the liquid crystalline medium has an absorption maximum for the chosen frequency.

As the physical properties of the liquid crystalline medium are temperature dependent, the method preferably further includes measuring of the temperature of the liquid crystalline medium and adjusting of the frequency of the heating signal and thus of the alternating electric field in dependence of the measured temperature.

The dependence of the absorption maximum used for dielectric heating on the temperature may, for example, be determined experimentally.

Preferably, the frequency of the heating signal is determined from the measured temperature by means of a look up table. The look up table may, for example, be prepared based on experimental data.

The loss tangent depends on the temperature and on the frequency of the heating signal.

FIG. 4a shows temperature and frequency dependence of the loss tangent perpendicular to the director of the liquid crystal and,

FIG. 4b shows temperature and frequency dependence of the loss tangent parallel to the director of the liquid crystal for an exemplary liquid crystalline medium.

A plurality of look-up tables is provided for different orientation states of the liquid crystal. The orientation depends on the control signal applied to control the state of the liquid crystal.

In a preferred embodiment, the liquid crystal is fully switched so that the liquid crystal is aligned parallel to the electric field before or while the heating signal is applied.

By means of a look up table, only few computational resources are required in a control unit implementing the adjustment of the frequency used for dielectric heating. For temperatures which are between two entries of the look up table, interpolation may be used.

Preferably, the frequency of the heating signal is adjusted in dependence of the power input of the dielectric heating of the antenna. A power input value is associated with each frequency value for a given orientation of the liquid crystal. A high power input corresponds to a high loss tangent and causes favourably fast heating of the liquid crystal and of the antenna. An operating frequency for heating may be selected as the frequency value that has the highest power input.

Preferably, the optimum frequency is determined by
i) sweeping said frequency through a predetermined frequency range while monitoring the power input of the antenna (10),
ii) determining the frequency from where the power input has a maximum.

Preferably, the method additionally comprises a method for tracking the optimum frequency comprising the steps of:
i) measuring the power input of the heating of the antenna
ii) determining whether or not a change has occurred in said power input, and if so,
iii) varying the frequency of the heating signal in response to said change so that the change of the power input with the frequency is adjusted to maintain a predetermined value, preferably zero.

Optionally, the result is stored electronically for future reference.

Preferably, the temperature of the liquid crystalline medium is measured via a temperature sensor arranged within the liquid crystalline medium or in proximity of the liquid crystalline medium.

Additionally or alternatively, the temperature is determining via measuring the capacitance of the liquid crystalline medium.

The capacitance of the liquid crystalline medium may, for example be measured using the same electrodes which are used to apply the electric field for controlling the state of the liquid crystalline medium and/or for applying the signal used for dielectric heating. The dependence of the capacitance on the temperature may, for example, be determined experimentally.

Preferably, a look up table is used for determining temperature from the measured capacitance. Again, the use of a look up table requires only few computational resources for performing the temperature control. For capacitance values which are between two entries of the look up table, interpolation may be used.

Preferably, the heating of the liquid crystalline medium is performed for temperatures of the liquid crystalline medium at or below 40° C., preferably in the range of from -40° C. to 40° C., more preferably from -35° C. to 20° C., and especially preferably in the range of from -30° C. to 10° C., in particular from -30° C. to 0° C.

Preferably, temperature control is performed and the temperature of the liquid crystalline medium is controlled to a predetermined temperature setpoint.

### BRIEF DESCRIPTION OF THE DRAWINGS

The drawings show:

FIG. 1 A schematic block diagram of a steerable antenna having four radiating elements,

FIG. 2 a schematic diagram of a modifier element configured as phase shifter,

FIG. 3 temperature and frequency dependence of the real part of the permittivity for an exemplary liquid crystalline medium, and

FIG. 4a temperature and frequency dependence of the loss tangent perpendicular to the director of the liquid crystal, for the exemplary liquid crystalline medium.

FIG. 4b temperature and frequency dependence of the loss tangent parallel to the director of the liquid crystal, for the exemplary liquid crystalline medium.

The figures are only a schematic, non-limiting representation of the invention.

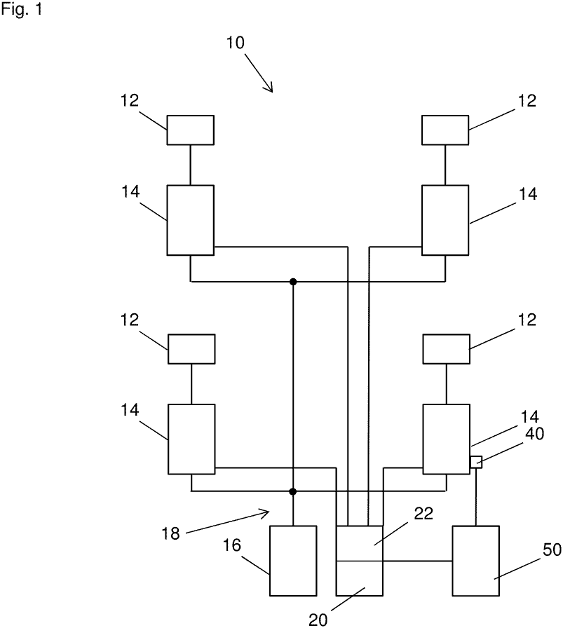

In FIG. 1, a schematic block diagram of a steerable antenna 10 having four radiating elements 12 is shown. The steerable antenna 10 has an antenna signal input 16 for supplying an antenna signal which is to be emitted by the steerable antenna 10. Further, the steerable antenna 10 comprises a control unit 50.

The steerable antenna 10 of FIG. 1 is configured as a phased array antenna, wherein each of the radiating elements 12 is connected via a modifier element 14 configured as phase shifter and a distribution network 18 to the antenna signal input 16. The radiating elements 12 are in the example of FIG. 1 arranged in a two by two array.

An antenna signal which is fed to the antenna signal input 16 is distributed by the distribution network 18 to the phase shifters which are connected to the radiating elements 12. If all phase shifters are configured to produce an in-phase output, the phase front of the radiated signal is aligned parallel to an antenna surface, therefore directing an antenna beam perpendicular to the antenna surface. When introducing a specific incremental phase shift, the phase front of the radiated fields is tilted and therefore the antenna beam is also tilted towards the desired direction.

The modifier elements 14 which are configured as phase shifters each comprise a liquid crystalline medium and the phase shift is dependent on a state of the liquid crystalline medium. The state of the liquid crystalline medium is controlled by means of an electric field, which is applied using electrodes arranged in the modifier element 14. The electric field is dependent on a control signal which is applied to said electrodes.

In the example embodiment shown in FIG. 1, the control unit 50 may be used to control the phase shifts required for steering the antenna beam. The control unit 50 is connected to a control signal generator 22 which is connected to each of the modifier elements 14 which are configured as phase shifters.

As the physical properties of the liquid crystalline medium are temperature dependent, it is necessary to ensure that at least the liquid crystalline medium of the modifier elements 14 of the steerable antenna 10 has a temperature within an operating temperature range. This is of particular importance for low temperature environments with a temperature below 0° C. In order to heat the liquid crystalline layer of the modifier elements 14, the steerable antenna 10 further comprises a heating signal generator 20 which is also connected to the modifier elements 14. The heating signal generator 20 is configured to provide a heating signal which is suitable for generating an electric field for dielectric heating of the liquid crystalline layer. Accordingly, the modifier elements 14 comprise electrodes which may be used to generate an electric field within the liquid crystalline medium when the heating signal is applied to said electrodes.

In the embodiment shown in FIG. 1, the heating signal generator 20 and the control signal generator 22 are configured as a common signal generator which generates a combined signal. The combined signal is then applied to a pair of electrodes arranged next to the liquid crystalline medium in each of the modifier elements 14.

In the embodiment shown in FIG. 1, the control unit 50 is further configured to control the temperature of the liquid crystalline medium of the modifier elements 14. Accordingly, the control unit 50 is connected to the heating signal generator 20 and is also connected to a temperature sensor 40 arranged in proximity to the liquid crystalline medium in one of the modifier elements 14. In another embodiment it is possible to arrange temperature sensors 40 for each of the modifier elements 14.

The control unit 50 may, for example, comprise a temperature controller such as a proportional-integral-derivative (PID) controller, for controlling the temperature of the liquid crystalline medium of the modifier elements 14 to a desired temperature setpoint using the feedback provided by the temperature sensor 40.

In order to select the optimal frequency for the heating signal, the control unit 50 may comprise a memory unit having a stored look up table. The entries of the look up table provide the correct frequency to be used for dielectric heating for the respective temperature of the liquid crystalline medium.

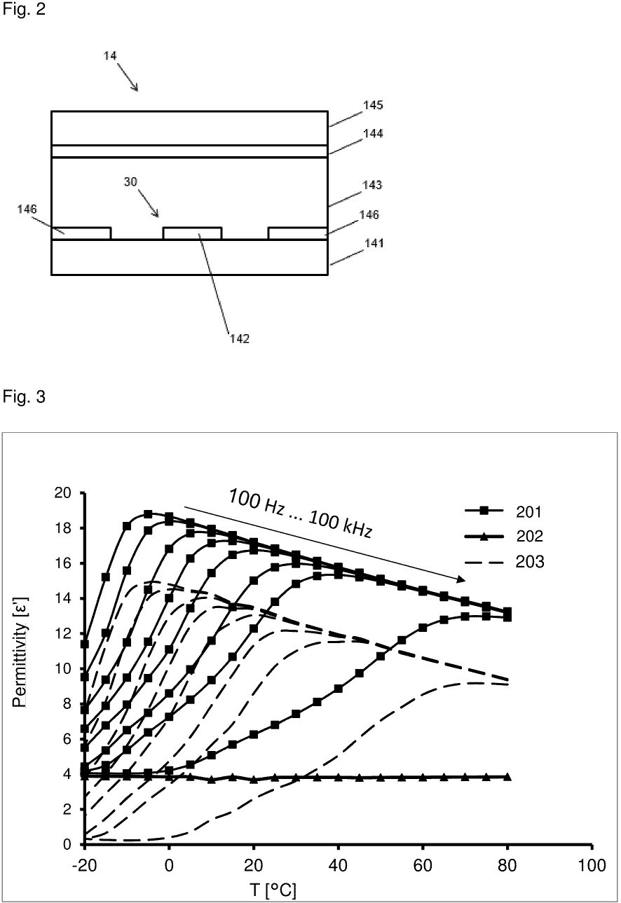

FIG. 2 shows a modifier element 14 configured as phase shifter in a schematic diagram.

The phase shifter comprises a microstrip line configured as a coplanar waveguide 30. The coplanar waveguide 30 comprises a signal line 142 arranged on a first substrate 141 which is connected to the distribution network 18 and a respective one of the radiating elements 12, see FIG. 1.

The signal line 142 is arranged on the first substrate 141 together with a pair of ground lines 146 arranged on either side of the signal line 142. For forming of a cavity for enclosing the liquid crystalline medium in form of a liquid crystal layer 143, a second substrate 145 is arranged facing the side of the first substrate 141 carrying the signal line 142. The gap width and thus the thickness of the liquid crystal layer 143 is typically less than 10 µm .

In the embodiment shown in FIG. 2, a top electrode 144 is arranged on the surface of the second substrate 145 facing towards the liquid crystal layer 143. For application of an electric field for controlling the state of the liquid crystalline medium of the liquid crystal layer 143, the signal line 142 may be used as first electrode. The top electrode 144 and/or the ground lines 146 may be used as second electrode for applying the electric field for controlling the state of the liquid crystalline medium as well as for applying the electric field for heating of the liquid crystalline medium.

The media N1 and N2 have the following compositions and physical properties

Example N1

| | |
|---|---|
| 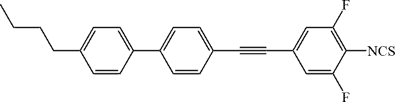 | 6% |
| 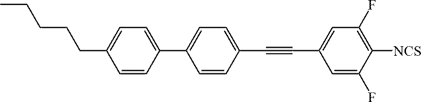 | 12% |
| 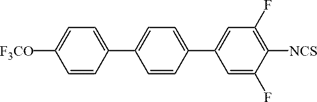 | 23% |
| 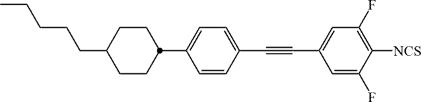 | 25% |
| 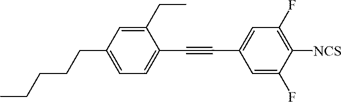 | 14% |
| 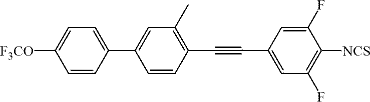 | 10% |
| 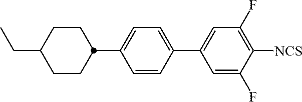 | 10% |

| | |
|---|---|
| Clearing Temperature [°C]: | 157 |
| Δε [1 kHz, 20° C.]: | 13.5 |
| εₗₗ [1 kHz, 20° C.]: | 17.2 |
| ε_{⊥} [1 kHz, 20° C.]: | 3.7 |
| K₁ [pN, 20° C.]: | 15.4 |
| K₃ [pN, 20° C.]: | 26.0 |
| V₀ [V, 20° C.]: | 1.12 |
| τ [20° C., 19 GHz]: | 0.33 |
| ε_{r,\|\|} [20° C., 19 GHz]: | 3.62 |
| ε_{r,⊥} [20° C., 19 GHz]: | 2.42 |
| tan δ_{ε} _{r,\|\|} [20° C., 19 GHz]: | 0.0053 |
| tan δ_{ε} _{r,⊥} [20° C., 19 GHz]: | 0.0086 |

Example N2

| | |
|---|---|
| 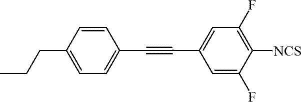 | 10% |
| 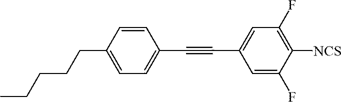 | 8% |
| 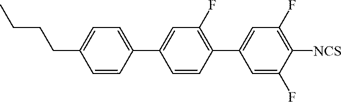 | 18% |
| 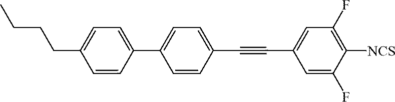 | 7% |
| 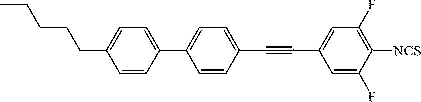 | 9% |
| 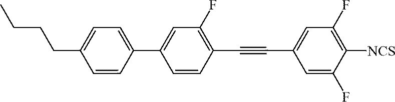 | 6% |
| 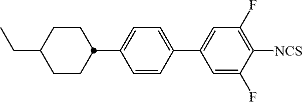 | 22% |
| 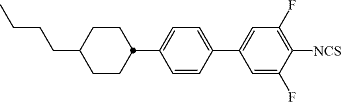 | 20% |

| | |
|---|---|
| Clearing Temperature [°C]: | 157 |
| Δε [1 kHz, 20° C.]: | 13.5 |
| ε_{\|\|} [1 kHz, 20° C.]: | 17.2 |
| ε⊥ [1 kHz, 20° C.]: | 3.7 |
| K₁ [pN, 20° C.]: | 15.4 |
| K₃ [pN, 20° C.]: | 26.0 |
| V₀ [V, 20° C.]: | 1.12 |

FIG. 3 shows the real part of the permittivity ε′ vs. temperature for an example liquid crystalline medium N1 for different frequencies ranging from 100 Hz to 100 kHz.

The first curves 201 depict the permittivity parallel to the molecular axis. The second curve 202 shows the permittivity perpendicular to the molecular axis for a frequency of 100 Hz. Only the second curve 202 for 100 Hz is shown as an example as the curves for the further frequencies up to 100 kHz differ only slightly. The third curves 203 show the difference Δε between the permittivity parallel and perpendicular to the molecular axis.

As can be seen from the diagram of FIG. 3, a maximum of the permittivity shifts with temperature.

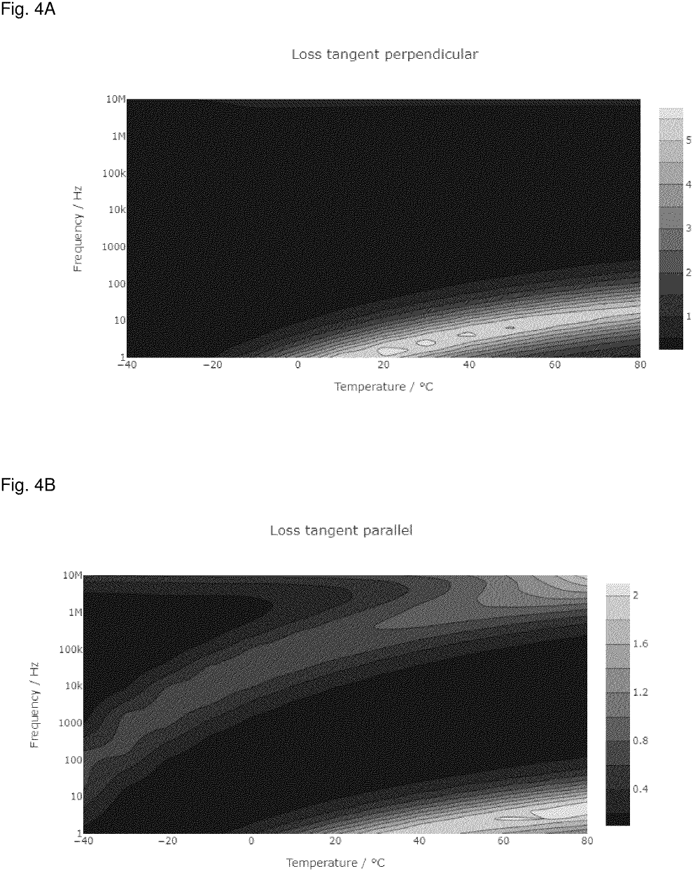

FIG. 4a shows the temperature and frequency dependence of the loss tangent perpendicular to the director for the liquid crystal mixture of example N2. For example, at 0° C. it is advantageous to apply a heating signal of 1 Hz for vertical orientation of the liquid crystal because the highest value of the loss tangent is observed here (tan δ = 3.61). Upon heating to 20° C. the maximum shifts to 1.58 Hz (tan δ = 5.67).

FIG. 4b shows the temperature and frequency dependence of the loss tangent parallel to the director for the liquid crystal medium N2. For example, at -30° C. the highest value of the loss tangent for parallel orientation is observed at a frequency of 631 Hz (tan δ = 0.685) which is the optimum frequency for dielectric heating in this case. Upon heating to e.g. -10° C., the optimum frequency, i.e. the maximum loss shifts to 10 kHz (tan δ = 0.717).

### LIST OF REFERENCE NUMERALS

10 steerable antenna
12 radiating element
14 modifier element
16 antenna signal input
18 distribution network
20 heating signal generator
22 control signal generator
30 (coplanar) waveguide
40 temperature sensor
50 control unit
141 first substrate
142 signal line
143 liquid crystal layer
144 top electrode
145 second substrate
146 ground line
201 first curves
202 second curves
203 third curves

1. Steerable antenna (10) comprising a plurality of radiating elements (12) and a plurality of modifier elements (14) configured for shifting phase and/or adjusting amplitude of a signal to be emitted by the radiating elements (12), wherein one or more of the radiating elements (12) is coupled to one or more of the modifier elements (14), wherein the modifier elements (14) each comprise a liquid crystalline medium and wherein the modifier elements (14) are configured such that the adjustment of the phase and/or amplitude is dependent on a state of the liquid crystalline medium, characterized in that the steerable antenna (10) further comprises a signal generator (20) connected to the modifier elements (14) and configured for generating a signal suited for dielectric heating of the liquid crystalline media of the modifier elements (14).

2. Steerable antenna (10) according to claim 1, wherein the radiating elements (12) are arranged in form of a grid or in form of concentric rings.

3. Steerable antenna (10) according to claim 1, wherein the modifier elements (14) are configured as phase shifters.

4. Steerable antenna (10) according to claim 3, wherein the antenna additionally comprises modifier elements (14) configured as variable attenuators.

5. Steerable antenna (10) according to claim 3, wherein the phase shifters have a waveguide (30).

6. Steerable antenna (10) according to claim 5, wherein the waveguide (30) is configured as microstrip line or coplanar waveguide arranged adjacent to a liquid crystal layer or as hollow waveguide at least partially filled with liquid crystalline medium.

7. Steerable antenna (10) according to claim 1, wherein the steerable antenna (10) further comprises a common waveguide with a plurality of slots, wherein the modifier elements (14) are arranged between the common waveguide and the slots.

8. Steerable antenna (10) according to claim 1, wherein each of the modifier elements (14) has at least two electrodes, wherein a first electrode is configured for applying an electric field for adjusting the orientation state of the liquid crystalline medium and a second electrode is connected to the signal generator (20) and configured to apply an electric field for dielectric heating of the liquid crystalline medium.

9. Steerable antenna (10) according to claim 1, wherein each of the modifier elements (14) has at least one electrode (144), which is configured for applying both an electric field for adjusting the orientation state of the liquid crystalline medium and is further connected to the signal generator (20) and configured to apply an electric field for dielectric heating of the liquid crystalline medium.

10. Steerable antenna (10) according to claim 1, wherein the steerable antenna (10) further comprises a temperature sensor (40) configured to measure a temperature of the liquid crystalline medium of the modifier elements (14).

11. Steerable antenna (10) according to claim 1, wherein a control unit (50) is provided which is configured to adjust the frequency of the signal suited for dielectric heating in dependence of the temperature of the liquid crystalline medium of the modifier elements (14).

12. Method of heating and/or tempering of a steerable antenna (10) comprising a plurality of radiating elements (12) and a plurality of modifier elements (14) configured for shifting phase and/or adjusting amplitude of an antenna signal to be emitted by the radiating elements (12), wherein one or more of the radiating elements (12) is coupled to one or more of the modifier elements (14), wherein the modifier elements (14) each comprise a liquid crystalline medium and wherein the modifier elements (14) are configured such that the adjustment of the phase and/or amplitude is dependent on a state of the liquid crystalline medium, characterized in that an alternating electric field having a frequency suited for dielectric heating of the liquid crystalline medium is applied to the liquid crystalline medium of the modifier elements (14).

13. The method of claim 12, wherein a temperature of the liquid crystalline medium is measured and the frequency of the alternating electric field is adjusted in dependence of the measured temperature.

14. The method of claim 13, wherein the frequency is determined from the measured temperature by means of a look up table.

15. The method of claim 12, wherein the frequency of the alternating electric field is adjusted in dependence of the power input of the dielectric heating of the antenna (10).

16. The method of claim 15, wherein the frequency is determined by
i) sweeping said frequency through a predetermined frequency range while monitoring the power input of the antenna (10),
ii) determining the frequency from where the power input has a maximum.

17. The method of claim 16, the method further comprising the steps of
i) measuring the power input of the dielectric heating of the antenna,
ii) determining whether or not a change has occurred in said power input, and if so,
iii) varying the frequency of the heating signal in response to said change so that the change of the power input with the frequency is adjusted to maintain a predetermined value.

18. The method of claim 13, wherein the temperature is measured via a temperature sensor (40) arranged within the liquid crystalline medium or in proximity of the liquid crystalline medium.

19. The method of claim 13, wherein the temperature is determined via measuring the capacitance of the liquid crystalline medium.

20. The method of claim 19, wherein a look up table is used for determining temperature from the measured capacitance.

21. The method of claim 12, wherein heating of the liquid crystalline medium is performed for temperatures of the liquid crystalline medium at or below 40° C., preferably in the range of from -40° C. to 40° C.

22. The method of claim 12, wherein temperature control is performed and the temperature of the liquid crystalline medium is controlled to a predetermined temperature set-point.

23. The method of claim 12, wherein the steerable antenna (10) further comprises a signal generator (20) connected to the modifier elements (14) and configured for generating a signal suited for dielectric heating of the liquid crystaline media of the modifier elements (14).

24. The method of claim 12, wherein heating of the liquid crystalline medium is performed for temperatures of the liquid crystalline medium in the range of from -40° C. to 40° C.
